(19) United States
(12) Patent Application Publication
(10) Pub. No.: US 2015/0066558 A1
(43) Pub. Date: Mar. 5, 2015

(54) CONTEXT AWARE COMMAND AND CONTROL SYSTEM

(71) Applicant: Thales Canada Inc., Toronto (CA)

(72) Inventors: Ehsan Kimiagar, Maple (CA); Firth Whitwam, Toronto (CA)

(21) Appl. No.: 14/013,462

(22) Filed: Aug. 29, 2013

(51) Int. Cl. G06Q 10/06; G06Q 50/30

(52) U.S. Cl. CPC G06Q 10/06313; G06Q 50/30
USPC 705/7.17

(57) ABSTRACT

A context aware command and control system includes a control system, such as a train control system or a mobile land forces command centre, a mobile device server and a mobile device application resident on a mobile device of the users of the resources being controlled. The control system receives information from the mobile devices such as, in the case of the public transportation application, boarding station, destination station, journey, purchased ticket, location of passenger, passenger with special need information, bus arrival and departure information, and social events information. The control system also receives information such as weather forecast, delays affecting resource delivery, notice of an expected special event with unknown timing parameters, e.g., a sporting event. The train control system analyzes the collected information in combination with historical data to adjust timing and configuration of resource availability in the network. The command and control system also provides data to the mobile application through the mobile server such as, in the case of the transportation application, passenger traffic load, delays, ticketing, train schedules, train traffic, system recommendations and system closure information.

### BACKGROUND

Current state of the art in command and control systems is to use historic or predictive data to identify the need for resources and create apriori schedules based on expected patterns of need to determine when to deliver the necessary resources to each location. A typical example of this is public transportation planning which creates fixed schedules for trains and/or buses and depends on the public to continue to demand the service in line with preplanned resources. This results in wasted use of resources if the situation changes and the command and control system does not adapt to these changes in how it supplies the resources.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or reduced for clarity of discussion.

FIG. 1 is a block diagram of a context aware command and control system in some embodiments as applied to a metropolitan railway application;

FIG. 2 is a block diagram of a server/client portion of a context aware command and control system in accordance with some embodiments;

FIG. 3A is a flow chart of a context aware command and control system in some embodiments;

FIG. 3B is a flow chart of a context aware command and control system as applied to a public transportation system in some embodiments; and

FIG. 4 is a block diagram of a computer portion of the context aware command and control system in some embodiments.

### DETAILED DESCRIPTION

The following disclosure provides many different embodiments, or examples, for implementing different features of the invention. Specific examples of components and arrangements are described below to simplify the present disclosure. These are examples and are not intended to be limiting.

To achieve greater efficiency in systems, a context aware capability is developed. Applying this to a public transportation system, relevant and informative data beyond historical ridership patterns is generated, exchanged, analyzed and acted upon to reschedule current train behaviours such as with real-time reschedule and real-time regulation of public transportation system operation, including changed train station dwell time, changed number of cars in a given train, scheduling additional stops, scheduling additional local and/or express trains, and adjusting/optimizing travel-time and headway in real-time to meet the demand and/or improve energy efficiency, etc. The relevant and informative data includes weather forecasts, traffic delays, large event schedules affecting public transportation use, such as popular sporting, musical and other events, and data reflecting real-time public transportation needs and use. The real time data is produced from a mobile telephone application that provides a two-way exchange of data between a mobile telephone user and mobile server. In some embodiments the mobile server supports cloud-based computing. This data is developed in conjunction with a mobile telephone application, received by the mobile server, and transmitted to a vehicle network control system to provide a context aware public transportation control system. In some embodiments the context aware public transportation control system is used to improve performance of an automated (driverless) train control system.

The context aware public transportation control system includes three main components; a vehicle network control system such as a train control system, a mobile server, and a mobile device application resident on a mobile device of a public transportation user or potential user. The vehicle network control system receives information from users using the mobile application executed on their mobile devices through one or more mobile servers. The information received from the mobile application includes the user's boarding station, destination station, ticketing information, special needs of the user and other relevant user specific information. The vehicle network control system also receives additional information, such as weather forecast, traffic delays, special events, e.g., sporting events, and other relevant non-user specific information. In some examples, the vehicle network control system also predicts special events based on passenger volume and destination information. In some examples, the additional information is received from the mobile application. In some examples, the additional information is received from external sources, such as venue calendars, traffic systems, meteorological data centers, etc. The vehicle network control system uses pattern recognition to analyze the collected information in combination with historical data to make a real time determination regarding operation of vehicles within a guideway network. The vehicle network control system also provides updates to the mobile application executed on the mobile device through the mobile server. The information provided to the application includes updated vehicle schedules, the number of passengers in a station, ticketing information, type of vehicle, e.g., local or express, alerts regarding service outages and other relevant information.

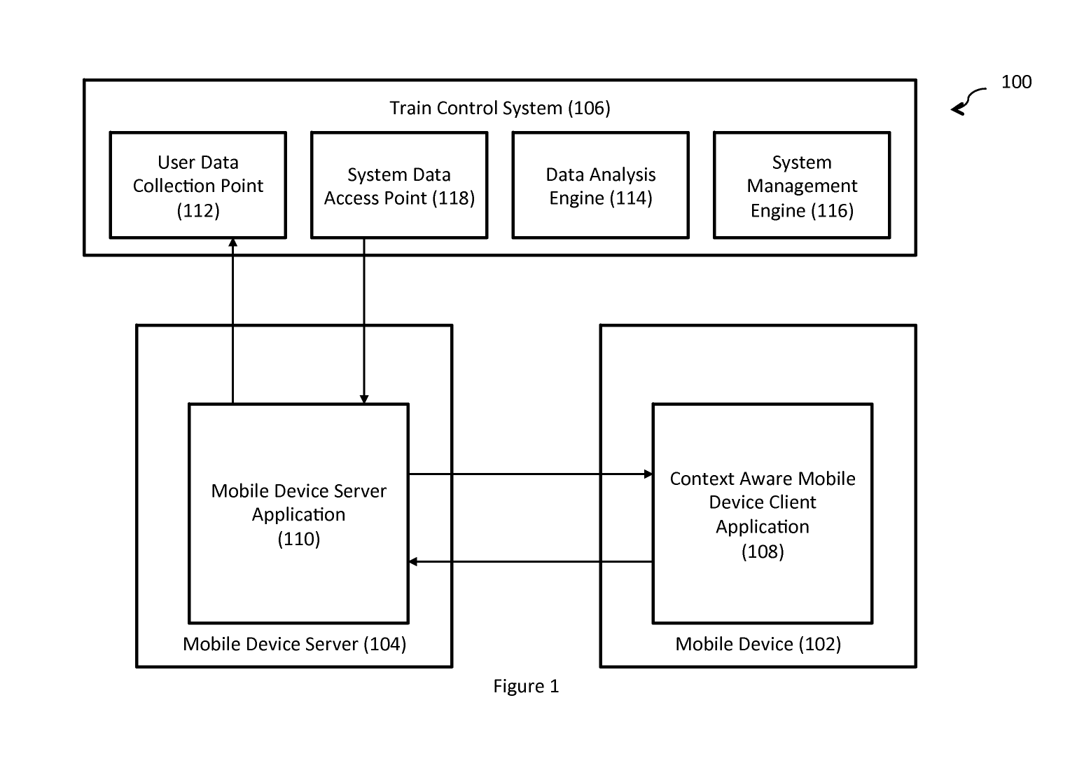

FIG. 1 is a block diagram of a context aware public transportation control system 100 in accordance with some embodiments. The context aware public transportation control system 100 includes a mobile device 102, a mobile device server 104 and a train control system 106. The mobile device 102 may be a tablet-type personal computer such as those made by Apple (iPad), Samsung (Galaxy), Microsoft (Surface), or Amazon (Kindle), or a smart mobile telephone such as those wireless cellular telephones made by Apple (iPhone), Motorola (Droid) and Samsung (Galaxy), etc., having the ability to support third party application software. In some embodiments, the mobile device 102 is another type of wireless data exchanging portable device, such as a laptop, etc. In accordance with a server/client model of some embodiments, the mobile device 102 supports a context aware mobile device client application (“mobile application”) 108 and the mobile device server 104 supports a mobile device server application 110. The mobile application 108 is in bidirectional communications with the mobile device server application 110. More specifically, the mobile application 108 uses the mobile device 102 to wirelessly transmit data to the mobile device server application 110 that resides on the mobile device server 104. The mobile device server application 110 uses the mobile device server 104 to wirelessly transmit data to the mobile application 108 on the mobile device 102. Note that while the mobile device 102 and the mobile device server 104 are described here in singular terms, a plurality of mobile devices and mobile device servers is also envisioned for the context aware public transportation system 100 in some embodiments.

Data received by the mobile device server application 110 from the mobile application 108 is transmitted by the mobile device server application 110 to a user data collection point 112 within the train control system 106. Data received by the user data collection point 112 is transmitted to the data analysis engine 114. Data from the data analysis engine 114, such as a transportation parameter relating to current ridership or predicted future ridership is provided to a system management engine 116 for making corresponding changes to public transportation conveyances. (examples of system management engines are System Management Centre SMC & Automatic Train Supervision ATS) In some embodiments the public transportation conveyances are trains. Data from the system management engine 116 is transferred to a system data access point 118. Data received by the system access point 118 in the train control system 106 is transmitted to the mobile device server application 110 in the mobile device server 104. Data from the mobile device server application 110 in the mobile device server 104 is transmitted to the mobile application 108 in the mobile device 102. Thus data is exchanged bidirectionally between the mobile device server 104 and the mobile device 102.

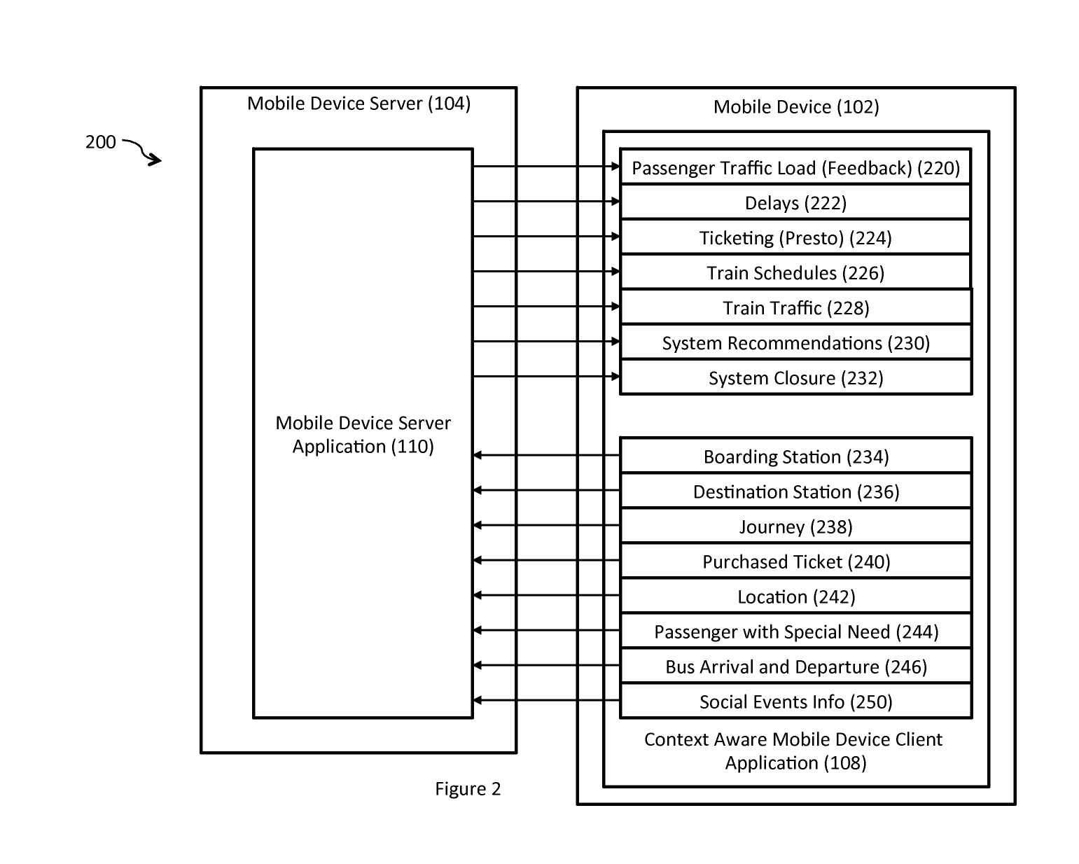

FIG. 2 is a block diagram of a server/client portion 200 of a context aware public transportation control system 100 in accordance with some embodiments. Data transmitted from the mobile device server application 110 being executed by the mobile device server 104 to the context aware mobile device client application (“mobile application”) being executed by the mobile device 102 includes passenger traffic load (feedback) 220. The passenger traffic load (feedback) 220 includes information on the measured passenger loads on currently deployed trains and predicted future passenger loads for trains. The passenger traffic load (feedback) 220 received by a user's mobile application is indicative of the current transportation conditions, i.e., the context, and in some embodiments is reviewed by the passenger to help that passenger plan their trip accordingly. Because some passengers may seek less crowded trains, for example, to improve their odds of finding a seat, not only is individual passenger experience improved for those passengers, overall efficiency of public transportation system is improved because the passenger loads may become more evenly distributed.

Data transmitted from the mobile device server application 110 to the mobile application includes delays 222. Delays 222 describe deviations from published schedules for the public transportation system. Similar to passenger traffic load (feedback) 220, delays 222 enables passengers to more efficiently plan their journeys, improving individual passenger experience and overall efficiency of the public transportation system.

The mobile application 108 receives data about ticketing, e.g., the information received by a Presto Card, such as those employed in Toronto, Canada. The Presto Card is a contactless smart card fare payment system for public transit systems used in portions of Ontario, Canada. The information received includes a reduction of balance associated with payment of a fare for a ticket to use public transportation, such as a commuter train. (ticketing info could also be available through a direct interface with Presto System) Other information associated with ticketing 224 includes information about loyalty programs, public transportation transfers, shared fares between different public transportation modes, such as trains and buses, etc. The mobile application also receives data from the mobile device server application that includes train schedules 226 for personal route planning, train traffic 228 to explain and anticipate delays, system recommendations 230 regarding travel modes and corresponding schedules, and notice of system closure 232. This data 226, 228, 230, 232 allows the user to gain a more complete picture of the public transportation context and options available, allowing the user to adjust their travel plans and/or expectations, thereby improving user experience.

Data transmitted to the mobile device server application 110 from the mobile application includes boarding station 234, destination station 236 and journey 238 information. This data 234, 236, 238 is received by mobile device server application 110 and transmitted to the user data collection point 112 in the train control system 106. The train control system 106 analyzes the data 234, 236, 238 to provide enhanced public transportation options as described herein. Other data transmitted to the mobile device server application 110 from the mobile application includes passenger location 242 and passenger with special need 244 information. This data 242, 244 enables the train control system to gain a clearer picture of the demands to be placed on the public transportation system in order to make corresponding adjustments to the transportation operation, including the transportation schedule. In some embodiments, location 242 includes longitude and latitude coordinates provided by a global positioning system (GPS) functionality found in some mobile devices.

Data transmitted to the mobile device server application 110 from the mobile application also includes real-time bus arrival and departure 246 information and real-time social events information 250. The social events information 250 includes in some embodiments derived or received information of the mobile device 102 user's intention to attend a social event. Data 246, 250 is used in conjunction with published schedules of bus routes and social events to provide highly accurate, real-time information about occurrences likely to affect a public transportation system, e.g., a public transportation system that includes buses and trains in some embodiments.

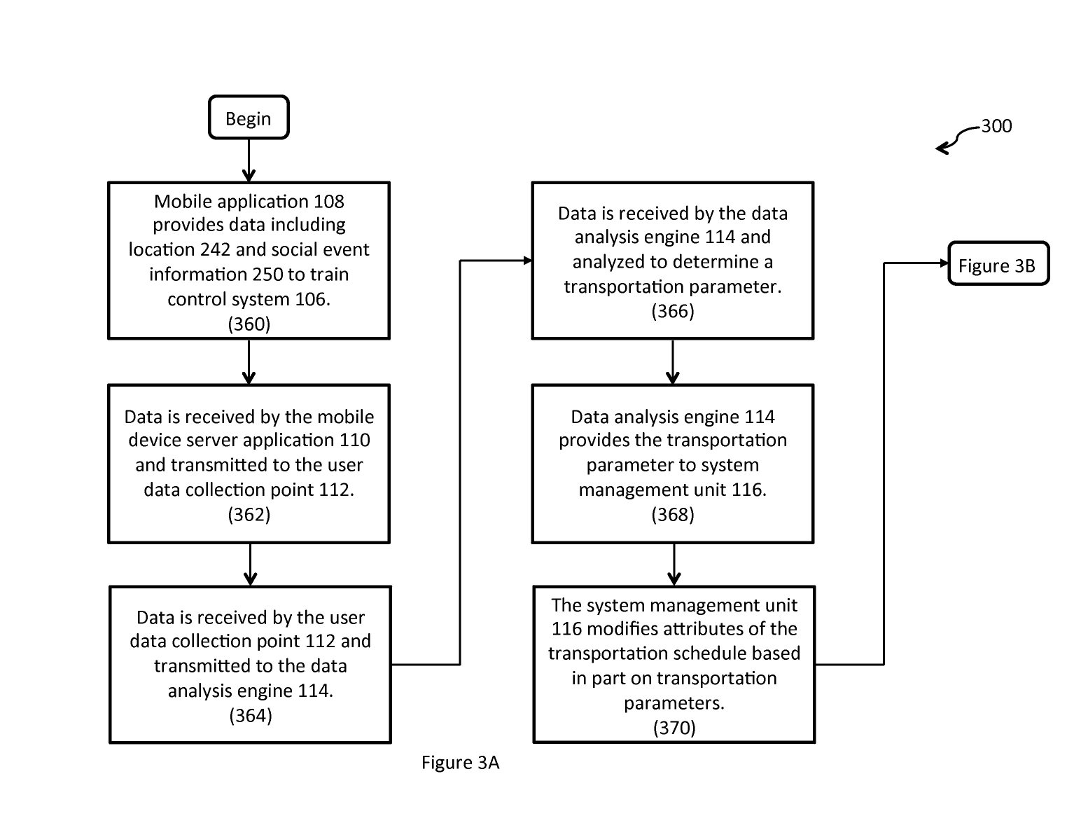

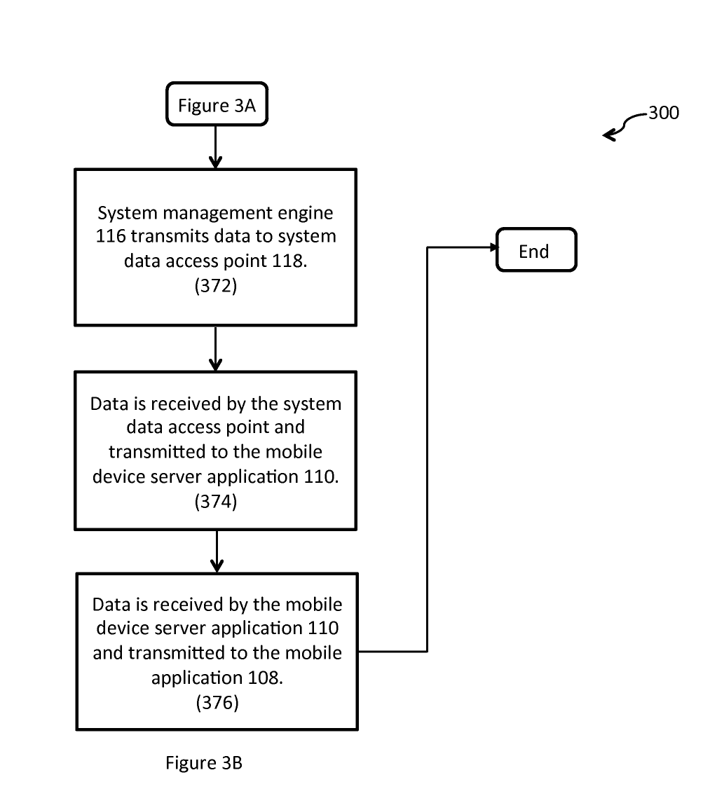

FIG. 3A is a flow chart of a method for providing a context aware public transportation control system 300 in some embodiments. For example, published schedules of social events and real-time social events information 250 can include information about a popular sporting event such a baseball, basketball, football, hockey, lacrosse, or soccer game that is scheduled to occur in an area serviced by public transportation. Other social events include musical and theatrical performances, etc. (high traffic areas such as universities, financial district). In operation 360 the mobile application 108 provides data including location 242 and social event information 250 designated or derived from a user of the mobile device 102. By way of example, in some embodiments information indicating that a user is planning on attending a particular major league baseball game is transmitted along with current user location. In operation 362 the data including location 242 and social event information 250 is received by the mobile device server application 110 and transmitted to the user data collection point 112 in the train control system 106. In some embodiments, social events are inferred and/or predicted based on passenger movement. For example, if a sports stadium, such as a soccer stadium, is located near a public transportation station and a presence of passengers in that station or a flow of passengers moving to/from that station as indicated by changing coordinates of location 242 exceeds certain values, a social event is inferred and/or predicted. In operation 366 the data including location 242 and social event information 250 is received and accessed by the data analysis engine 114 along with corresponding data from other mobile devices 102 to derive one or more transportation parameters associated the public transportation system 100. In this example the data analysis engine 114 determines three different subway lines will experience three different passenger volume increases. In operation 368 the data analysis engine 114 provides the transportation parameters it derived predicting three different passenger volume increases to the system management unit 116. For example, a first passenger train line is predicted to experience a 20% increase in expected train passengers (as compared to historical averages), a second passenger train line is predicted to experience a 55% increase in expected train passengers, and a third passenger train line is predicted to experience a 160% increase in expected train passengers.

In operation 370 the system management unit 116 modifies attributes of the transportation operation based at least in part on the transportation parameter received from the data analysis engine 114. The transportation parameters associated with the public transportation system 100 are used by the system management engine 116 to reschedule the public transportation system, including train station dwell time, number of cars in a given train, scheduling additional stops, scheduling additional local and/or express trains, and adjusting traveltimes and headway, etc. In a first instance the system management unit 116 increases the dwell time of a train at certain train stations to allow more passengers to board. In a second instance the system management unit 116 increases dwell time and couples additional cars to a train. In the third instance the system management unit schedules an additional train to run during a predicted peak passenger volume time to accommodate those baseball fans traveling by public transportation to attend (or from) the baseball game.

FIG. 3B is a flow chart of a method for providing a context aware public transportation control system 300 in some embodiments. By way of example, in operation 372, the system management engine 116 transmits data to the system data access point 118 corresponding to the adjustments made in the previous step, including passenger traffic load 220, delays 222, ticketing, 224, train schedules 226, train traffic 228, system recommendations 230 and system closure 232. The system management unit 116 is not limited to these forms of data and other forms of data are envisioned. In operation 374 data from the system data access point 118 is transmitted to the mobile device server application 110 in the mobile device server 104.

In operation 376, data from the mobile device server application 110 on the mobile device server 104 is transmitted to the mobile application 108 residing on the mobile device 102. In this example the user notes that there is system recommendation to consider a newly scheduled train as a possibly more efficient way for the user to be transported to the baseball game and elects to accept the system recommendation, ultimately saving an amount of time significant to the user, thereby improving that user's experience. In some other embodiments, train operation is adjusted based on passenger travel patterns not tied to any particular social event, for example, one or more passengers driving to a train station might be advanced or delayed for unknown reasons and the context aware public transportation control system 100 compensates in real-time for such actual passenger conditions.

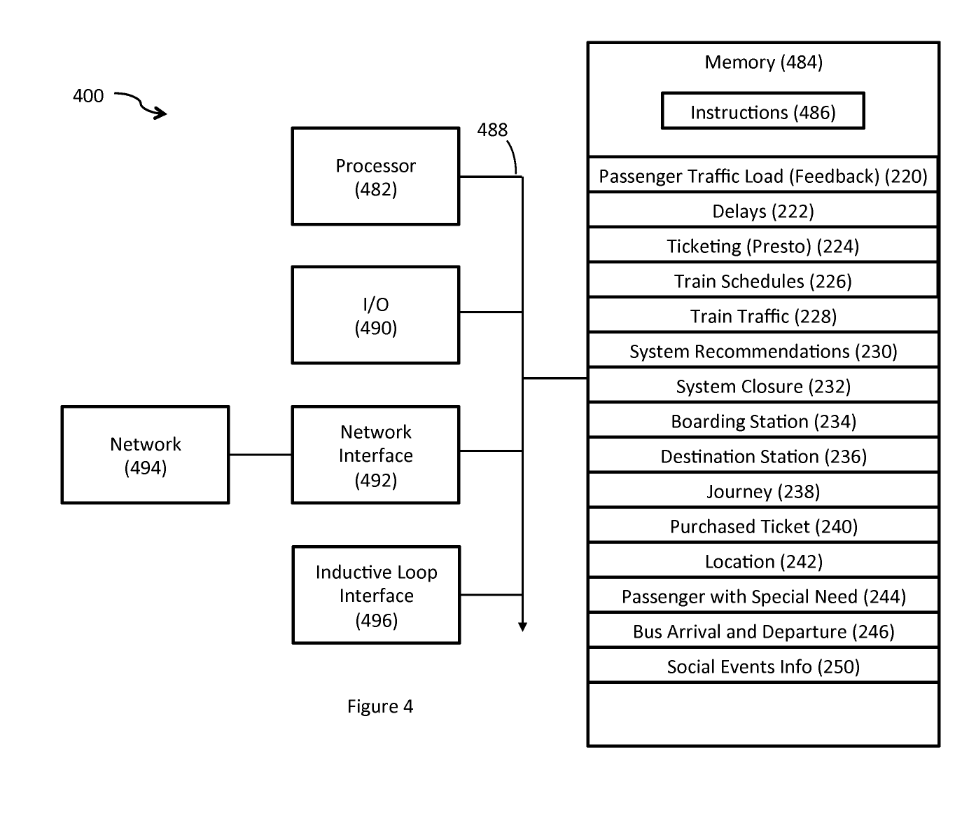

FIG. 4 is a block diagram of a computer system portion 400 of the context aware public transportation control system 100 in some embodiments. In some embodiments, the computer system 400 is train control system 106 (FIG. 1). In other embodiments, the computer system 400 is mobile device server 104. In still other embodiments, the computer system 400 is the mobile device 102. Computer system 400 includes a hardware processor 482 and a non-transitory, computer readable storage medium 484 encoded with, i.e., storing, the computer program code 486, i.e., a set of executable instructions. Computer readable storage medium 484 is also encoded with data representing passenger traffic load (feedback) 220, delays 222, ticketing (Presto), train schedules 226, train traffic 228, system recommendations 230, system closure 232, boarding station 234, destination station 236, journey 238, purchased ticket 240, location 242, passenger with special need 244, bus arrival and departure 246 and social events info 250 for use with the context aware public transportation control system 100 in some embodiments. The processor 482 is electrically coupled to the computer readable storage medium 484 via a bus 488. The processor 482 is also electrically coupled to an I/O interface 490 by bus 408. A network interface 492 is also electrically connected to the processor 402 via bus 488. Network interface 492 is connected to a network 494, so that processor 482 and computer readable storage medium 484 are capable of connecting and communicating to external elements via network 494. An inductive loop interface 496 is also electrically connected to the processor 482 via bus 488. Inductive loop interface 496 provides a diverse communication path from the network interface 492. In some embodiments, inductive loop interface 496 or network interface 492 are replaced with a different communication path such as optical communication, microwave communication, or other suitable communication paths. The processor 482 is configured to execute the computer program code 486 encoded in the computer readable storage medium 484 in order to cause computer system 400 to be usable for performing a portion or all of the operations as described with respect to the context aware public transportation control system 100 and method 300 (FIGS. 3A and 3B).

In some embodiments, the processor 482 is a central processing unit (CPU), a multi-processor, a distributed processing system, an application specific integrated circuit (ASIC), and/or a suitable processing unit.

In some embodiments, the computer readable storage medium 484 is an electronic, magnetic, optical, electromagnetic, infrared, and/or a semiconductor system (or apparatus or device). For example, the computer readable storage medium 484 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 484 includes a compact disk-read only memory (CD-ROM), a compact disk-read/write (CD-R/W), a digital video disc (DVD) and/or Blu-Ray Disk.

In some embodiments, the storage medium 484 stores the computer program code 486 configured to cause computer system 400 to perform the operations as described with respect to mobile device 102 (FIG. 1), mobile device server 104 (FIG. 1) or train control system 106 (FIG. 1). In some embodiments, the storage medium 484 also stores instructions and data needed for performing the operations as described with respect to the context aware public transportation control system 100 or method 300, such as data representing passenger traffic load (feedback) 220, delays 222, ticketing (Presto), train schedules 226, train traffic 228, system recommendations 230, system closure 232, boarding station 234, destination station 236, journey 238, purchased ticket 240, location 242, passenger with special need 244, bus arrival and departure 246 and social events info 250 and/or a set of executable instructions to perform the operation as described with respect to the context aware public transportation control system 100 and method 300.

In some embodiments, the storage medium 484 stores instructions 486 for interfacing with external components. The instructions 486 enable processor 482 to generate operating instructions readable by the external components to effectively implement the operations as described with respect to the context aware public transportation control system 100 and method 300.

Computer system 400 includes I/O interface 490. I/O interface 490 is coupled to external circuitry. In some embodiments, I/O interface 490 includes a keyboard, keypad, mouse, trackball, trackpad, and/or cursor direction keys for communicating information and commands to processor 482.

Computer system 400 also includes network interface 492 coupled to the processor 482. Network interface 492 allows computer system 400 to communicate with network 494, to which one or more other computer systems are connected. Network interface 492 includes wireless network interfaces such as BLUETOOTH, WIFI, WIMAX, GPRS, or WCDMA; or wired network interface such as ETHERNET, USB, or IEEE-1394. In some embodiments, the operations as described with respect to the context aware public transportation control system 100 and method 300 are implemented in two or more computer systems 400, and data representing passenger traffic load (feedback) 220, delays 222, ticketing (Presto), train schedules 226, train traffic 228, system recommendations 230, system closure 232, boarding station 234, destination station 236, journey 238, purchased ticket 240, location 242, passenger with special need 244, bus arrival and departure 246 and social events info 250 are exchanged between different computer systems 400 via network 494.

Computer system 400 also includes inductive loop interface 496 coupled to the processor 482. Inductive loop interface 496 allows computer system 400 to communicate with external devices, to which one or more other computer systems are connected. In some embodiments, the operations as described with respect to the context aware public transportation control system 100 and method 300 are implemented in two or more computer systems 400, and data representing passenger traffic load (feedback) 220, delays 222, ticketing (Presto), train schedules 226, train traffic 228, system recommendations 230, system closure 232, boarding station 234, destination station 236, journey 238, purchased ticket 240, location 242, passenger with special need 244, bus arrival and departure 246 and social events info 250 are exchanged between different computer systems 400 via inductive loop interface 415.

Computer system 400 is configured to receive information related to the instructions 486 through I/O interface 410. The information is transferred to processor 482 via bus 488 to determine corresponding adjustments to the transportation operation. The instructions are then stored in computer readable medium 484 as instructions 486. Computer system 400 is configured to receive data representing passenger traffic load (feedback) 220, delays 222, ticketing (Presto), train schedules 226, train traffic 228, system recommendations 230, system closure 232, boarding station 234, destination station 236, journey 238, purchased ticket 240, location 242, passenger with special need 244, bus arrival and departure 246 and social events info 250 through I/O interface 490.

Some embodiments include a context aware public transportation control system, the context aware public transportation control system configured to modify a transportation operation and configured to be communicatively coupled with a mobile device having a mobile device application. The context aware public transportation control system comprises a mobile device server and a train control system. The mobile device server has a mobile device server application. The mobile device server is configured to be communicatively coupled with the mobile device for exchanging data. The train control system is also configured to be communicatively coupled with the mobile device server for exchanging the data. The train control system has a data analysis engine and a system management engine. The data analysis engine is configured to derive a transportation parameter from the data through pattern recognition or other methods. The system management engine is configured to change the transportation operation based at least in part on the transportation parameter.

Some embodiments include a method for providing a context aware public transportation control system. The method includes receiving data from a mobile application with a mobile device server, transmitting the data from the mobile device server to a train control system, analyzing the data with the train control system to determine a transportation parameter and changing a train schedule based at least in part on the transportation parameter.

Some embodiments include a method controlling a guideway, the guideway associated with a passenger or potential passenger, the passenger or potential passenger having a mobile telecommunication device, the mobile telecommunication device having a mobile application. The method includes receiving data from the mobile application, receiving data from a public source about a upcoming social event, then based at least in part on data from the mobile application and data from the public source, predicting future guideway ridership associated with the upcoming social event, comparing future guideway ridership associated with the upcoming social event with a scheduled guideway vehicle configuration or capacity, and changing the scheduled guideway vehicle configuration to a different configuration correlating with the future guideway ridership. For example, the scheduled guideway vehicle configuration can be changed to include an additional car(s).

One of ordinary skill in the art will recognize the operations of method 300 are merely examples and additional operations are includable, describe operations are removable and an order of operations are adjustable without deviating from the scope of method 300.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A context aware command and control system, the context aware system being configured to modify operational behaviour and configured to being communicatively coupled with a mobile device having a mobile device application, the context aware command and control system comprising:
a mobile device server, the mobile device server having a mobile device server application, the mobile device server configured to being communicatively coupled with the mobile device for exchanging data; and
a command and control system, the system configured to being communicatively coupled with the mobile device server for exchanging the data, the command and control system having a data analysis engine and a system management engine, the data analysis engine configured to derive an operational parameter from the data, the system management engine configured to change the operational behaviour based at least in part on the real time status of the parameter being derived.

2. The context aware command and control system of claim 1, wherein the mobile device is a tablet computer or a cellular telephone and wherein the mobile device server is configured to be wirelessly coupled with the mobile device.

3. The context aware command and control system of claim 1, wherein the system is applied in the public transportation context and the schedule comprises guideway vehicle timings and the system management engine changes a guideway vehicle timing.

4. The context aware public transportation control system of claim 3, wherein the schedule comprises guideway vehicle configurations and the system management engine is configured to change a guideway vehicle configuration.

5. The context aware public transportation control system of claim 3, wherein the schedule comprises guideway vehicle timings and the system management engine is configured to augment the schedule with an additional guideway vehicle timing.

6. The context aware public transportation control system of claim 3, wherein the data includes social event information transmitted from the mobile device to the mobile device server.

7. The context aware public transportation control system of claim 3, wherein the data includes a train schedule transmitted from the mobile device server to the mobile device.

8. The context aware public transportation control system of claim 3, wherein the data includes train traffic information transmitted from the mobile device server to the mobile device.

9. The context aware public transportation control system of claim 3, wherein the data includes ticketing data transmitted from the mobile device server to the mobile device.

10. The context aware public transportation control system of claim 1, wherein the data includes a system recommendation transmitted from the mobile device server to the mobile device.

11. A method for providing a context aware command and control system, comprising the steps of:
receiving data from a mobile application with a mobile device server;
transmitting the data from the mobile device server to a train control system;
analyzing the data with the train control system to determine a operational parameter;
changing system operation based at least in part on the operational parameter.

12. The method for providing a context aware command and control system of claim 11, wherein the mobile application resides on a mobile device and wherein the mobile device server is wirelessly coupled with the mobile device for exchanging data.

13. The method for providing a context aware command and control system of claim 11, in a public transportation context wherein the train schedule comprises guideway vehicle timings and the changing of a train operation further comprises changing a guideway vehicle timing.

14. The method for providing a context aware public transportation control system of claim 13, wherein the train schedule comprises guideway vehicle configurations and the system management engine changes a guideway vehicle configuration.

15. The method for providing a context aware public transportation control system of claim 13, wherein the schedule comprises guideway vehicle timings and the system management engine augments the schedule with an additional guideway vehicle timing.

16. The method for providing a context aware public transportation control system of claim 13, wherein the data includes a train schedule transmitted from the mobile device server to the mobile application.

17. The method for providing a context aware public transportation control system of claim 13, wherein the data includes a train traffic information transmitted from the mobile device server to the mobile application.

18. The method for providing a context aware public transportation control system of claim 13, wherein the data includes ticketing data transmitted from the mobile device server to the mobile device.

19. The method for providing a context aware command and control system of claim 11, wherein the data includes a system recommendation transmitted from the mobile device server to the mobile device.

20. A method for controlling a guideway, the guideway associated with a passenger or potential passenger, the passenger or potential passenger having a mobile telecommunication device, the mobile telecommunication device having a mobile application, comprising the steps of:
receiving data from the mobile application;
receiving data from a public source about a upcoming social event;
based at least in part on data from the mobile application and data from the public source, predicting future guideway ridership associated with the upcoming social event,
comparing future guideway ridership associated with the upcoming social event with a scheduled guideway vehicle configuration or capacity; and
changing the scheduled guideway vehicle configuration to a different configuration correlating with the future guideway ridership.
